(19) United States
(12) Patent Application Publication
(10) Pub. No.: US 2025/0210677 A1
(43) Pub. Date: Jun. 26, 2025

(54) FUEL CELL PUMP

(71) Applicant: KABUSHIKI KAISHA TOYOTA JIDOSHOKKI, Kariya-shi (JP)

(72) Inventor: Yuki HIURA, Kariya-shi (JP)

(73) Assignee: KABUSHIKI KAISHA TOYOTA JIDOSHOKKI, Kariya-shi (JP)

(21) Appl. No.: 18/970,117

(22) Filed: Dec. 5, 2024

(30) Foreign Application Priority Data
Dec. 26, 2023 (JP) 2023-219407

(51) Int. Cl. H01M 8/04746; H01M 8/04223; H01M 8/04302; H01M 8/0432

(52) U.S. Cl. CPC H01M 8/04753; H01M 8/04253; H01M 8/04302; H01M 8/04365

(57) ABSTRACT

A processing circuitry of a fuel cell pump is configured to execute a process including a rapid acceleration rotation start and subsequent low acceleration rotation start when a detected temperature is lower than or equal to a preset temperature, and to execute a normal start mode process in other cases. The processing circuitry is configured to, in the rapid acceleration rotation start, set a value of a starting current supplied to a motor and a rotational acceleration of the motor to be greater than those in the normal start mode process. The processing circuitry is configured to, in the low acceleration rotation start, set the value of the starting current supplied to the motor to be greater than that in the normal start mode process, and set the rotational acceleration of the motor to be lower than that at the execution of the rapid acceleration rotation start.

### CROSS-REFERENCE TO RELATED APPLICATIONS

This application is based upon and claims the benefit of priority from Japanese Patent Application No. 2023-219407, filed on Dec. 26, 2023, the entire contents of which are incorporated herein by reference.

### BACKGROUND

### 1. Field

The present disclosure relates to a fuel cell pump.

### 2. Description of Related Art

Vehicles having a fuel cell system have recently been in practical use. The fuel cell system includes a fuel cell that generates power by producing a chemical reaction of hydrogen as a fuel gas with oxygen as an oxidant gas that is contained in the air. A fuel cell pump is used, for example, as a pump that supplies hydrogen to the fuel cell. For example, Japanese Laid-Open Patent Publication No. 2006-283664 discloses an example of a fuel cell pump.

The fuel cell pump described in the above publication includes a drive shaft, a driven shaft, a motor, a drive gear, a driven gear, a drive rotor, a driven rotor, and a housing. The motor rotates the drive shaft. The drive gear is fixed to the drive shaft. The driven gear is fixed to the driven shaft and meshes with the drive gear. The drive rotor rotates integrally with the drive shaft. The driven rotor rotates integrally with the driven shaft and meshes with the drive rotor. The housing includes a gear chamber and a pump chamber. The gear chamber accommodates the drive gear and the driven gear. Oil is sealed in the gear chamber. The oil contributes to lubrication of the drive gear and the driven gear and suppression of temperature increase. The pump chamber accommodates the drive rotor and the driven rotor. The fuel cell pump includes a control unit. The control unit controls operation of the motor. The fuel cell pump supplies hydrogen to the fuel cell through synchronous rotation of the drive rotor and the driven rotor.

In the fuel cell pump, hydrogen that has not reacted with oxygen in the fuel cell (hydrogen off-gas) is drawn into the pump chamber. The hydrogen off-gas contains water generated during power generation in the fuel cell. Thus, for example, when the operation of the fuel cell pump is stopped in a low-temperature environment, the water in the pump chamber freezes into ice. In the pump chamber, if water freezes into ice between the inner surface of the housing defining the pump chamber and the set of the drive rotor and the driven rotor, the drive rotor and the driven rotor may be adhered to the housing by the ice.

When the operation of the fuel cell pump is stopped in a low-temperature environment, the temperature of the oil in the gear chamber is relatively low. The viscosity of oil increases as the temperature decreases. The higher the viscosity of oil, the more difficult it is for the drive gear and the driven gear to rotate when the fuel cell pump is started. This extends the time required to start the fuel cell pump.

Therefore, it is desirable to solve the above-mentioned issues that may arise during the start of the fuel cell pump in low-temperature environments.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a general aspect, a fuel cell pump includes a drive shaft and a driven shaft, a motor configured to rotate the drive shaft, a drive gear fixed to the drive shaft, a driven gear fixed to the driven shaft and meshing with the drive gear, a drive rotor configured to rotate integrally with the drive shaft, a driven rotor configured to rotate integrally with the driven shaft and to mesh with the drive rotor, a housing, and a control unit. The housing includes a gear chamber and a pump chamber. The gear chamber accommodates the drive gear and the driven gear. Oil is sealed in the gear chamber. The pump chamber accommodates the drive rotor and the driven rotor. The control unit is configured to control operation of the motor. The fuel cell pump is configured to supply a fuel gas or an oxidant gas to a fuel cell through synchronous rotation of the drive rotor and the driven rotor. The control unit is configured to be electrically connected to a temperature sensor configured to detect a temperature. The control unit includes processing circuitry. The processing circuitry is configured to execute a normal start mode process when the temperature detected by the temperature sensor is higher than a preset temperature, and execute a low-temperature start mode process when the temperature detected by the temperature sensor is lower than or equal to the preset temperature. The low-temperature start mode process is a process of executing a rapid acceleration rotation start and then executing a low acceleration rotation start. The processing circuitry is configured to, in the rapid acceleration rotation start, set a value of a starting current supplied to the motor to be greater than that at the execution of the normal start mode process, and set a rotational acceleration of the motor to be higher than that at the execution of the normal start mode process. The processing circuitry is also configured to, in the low acceleration rotation start, set the value of the starting current supplied to the motor to be greater than that at the execution of the normal start mode process, and set the rotational acceleration of the motor to be lower than that at the execution of the rapid acceleration rotation start.

Other features and aspects will be apparent from the following detailed description, the drawings, and the claims.

### BRIEF DESCRIPTION OF THE DRAWINGS

FIG. 1 is a cross-sectional view showing a fuel cell pump according to an embodiment.

FIG. 2 is a cross-sectional view taken along line 2-2 in FIG. 1.

FIG. 3 is a graph showing an example of a current waveform when the fuel cell pump shown in FIG. 1 is started by executing a low-temperature start mode process.

FIG. 4 is a graph showing changes in the rotation speed of the motor shown in FIG. 1 in the low-temperature start mode process.

FIG. 5 is a flowchart illustrating a control executed by the control unit shown in FIG. 1.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

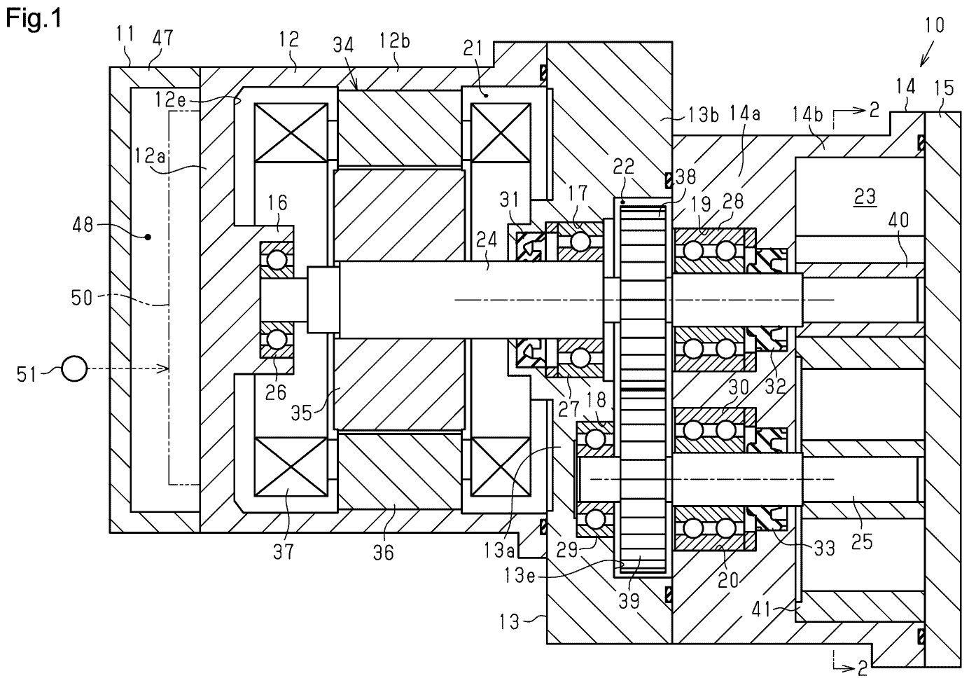

A fuel cell pump 10 according to one embodiment will now be described with reference to FIGS. 1 to 5. The fuel cell pump 10 of the present embodiment is used as a pump that supplies hydrogen as a fuel gas to a fuel cell that generates power by causing a chemical reaction of the hydrogen with oxygen contained in the air as an oxidant gas.

### Overview of Fuel Cell Pump

As shown in FIG. 1, the fuel cell pump 10 includes a housing 11. The housing 11 is tubular. The housing 11 is made of metal. The housing 11 is made of, for example, aluminum. The housing 11 includes a motor housing member 12, a gear housing member 13, a rotor housing member 14, and a cover member 15.

The motor housing member 12 includes a plate-shaped end wall 12a and a tubular peripheral wall 12b. The peripheral wall 12b extends from the outer periphery of the end wall 12a. The motor housing member 12 includes a cylindrical boss 16. The boss 16 protrudes from a central portion of an inner surface 12e on the side of the end wall 12a from which the peripheral wall 12b extends. The axis of the boss 16 agrees with the axis of the peripheral wall 12b.

The gear housing member 13 includes a plate-shaped end wall 13a and a tubular peripheral wall 13b. The peripheral wall 13b extends from the outer periphery of the end wall 13a. The gear housing member 13 is coupled to an open end of the peripheral wall 12b of the motor housing member 12. The end wall 13a of the gear housing member 13 closes the opening of the peripheral wall 12b of the motor housing member 12.

The gear housing member 13 includes a through-hole 17. The through-hole 17 has a circular shape. The through-hole 17 extends through the end wall 13a in the thickness direction of the end wall 13a. The axis of the through-hole 17 agrees with the axis of the boss 16. The gear housing member 13 includes a recess 18. The recess 18 is formed in an inner surface 13e of the end wall 13a that faces the rotor housing member 14. The recess 18 is circular. The axis of the recess 18 extends parallel to the axis of the through-hole 17.

The rotor housing member 14 includes a plate-shaped end wall 14a and a tubular peripheral wall 14b. The peripheral wall 14b extends from the outer periphery of the end wall 14a. The rotor housing member 14 is coupled to an open end of the peripheral wall 13b of the gear housing member 13. The end wall 14a of the rotor housing member 14 closes the opening of the peripheral wall 13b of the gear housing member 13. The axial direction of the peripheral wall 12b of the motor housing member 12, the axial direction of the peripheral wall 13b of the gear housing member 13, and the axial direction of the peripheral wall 14b of the rotor housing member 14 agree with each other.

The rotor housing member 14 includes a through-hole 19. The through-hole 19 has a circular shape. The through-hole 19 extends through the end wall 14a in the thickness direction of the end wall 14a. The axis of the through-hole 19 agrees with the axis of the through-hole 17. The rotor housing member 14 includes a through-hole 20. The through-hole 20 has a circular shape. The through-hole 20 extends through the end wall 14a in the thickness direction of the end wall 14a. The axis of the through-hole 20 agrees with the axis of the recess 18. Accordingly, the axis of the through-hole 19 extends parallel to the axis of the through-hole 20.

The cover member 15 has the shape of a plate. The cover member 15 is coupled to an open end of the peripheral wall 14b of the rotor housing member 14. The cover member 15 closes the opening of the peripheral wall 14b in a state of facing the end wall 14a.

The housing 11 includes a motor chamber 21, a gear chamber 22, and a pump chamber 23. The motor chamber 21 is defined by the end wall 12a of the motor housing member 12, the peripheral wall 12b of the motor housing member 12, and the end wall 13a of the gear housing member 13. The gear chamber 22 is defined by the end wall 13a of the gear housing member 13, the peripheral wall 13b of the gear housing member 13, and the end wall 14a of the rotor housing member 14. The pump chamber 23 is defined by the end wall 14a of the rotor housing member 14, the peripheral wall 14b of the rotor housing member 14, and the cover member 15.

The fuel cell pump 10 includes a drive shaft 24 and a driven shaft 25. The drive shaft 24 has a first end disposed inside the boss 16. The drive shaft 24 extends so as to pass through the motor chamber 21, the through-hole 17, the gear chamber 22, and the through-hole 19. The drive shaft 24 has a second end disposed in the pump chamber 23. A bearing 26 is provided between the drive shaft 24 and the inner peripheral surface of the boss 16. The drive shaft 24 is rotatably supported by the boss 16 with the bearing 26. A bearing 27 is provided between the drive shaft 24 and the inner peripheral surface of the through-hole 17. The drive shaft 24 is rotatably supported by the end wall 13a of the gear housing member 13 with the bearing 27. A bearing 28 is provided between the drive shaft 24 and the inner peripheral surface of the through-hole 19. The drive shaft 24 is rotatably supported by the end wall 14a of the rotor housing member 14 with the bearing 28.

The driven shaft 25 has a first end disposed inside the recess 18. The driven shaft 25 extends so as to pass through the gear chamber 22 and the through-hole 20. The driven shaft 25 has a second end disposed in the pump chamber 23. A bearing 29 is provided between the driven shaft 25 and the inner peripheral surface of the recess 18. The driven shaft 25 is rotatably supported by the end wall 13a of the gear housing member 13 with the bearing 29. A bearing 30 is provided between the driven shaft 25 and the inner peripheral surface of the through-hole 20. The driven shaft 25 is rotatably supported by the end wall 14a of the rotor housing member 14 with the bearing 30.

In this manner, the drive shaft 24 and the driven shaft 25 are rotatably supported by the housing 11. The drive shaft 24 and the driven shaft 25 are disposed in parallel to each other in the housing 11. The axial direction of the drive shaft 24 and the axial direction of the driven shaft 25 agree with the axial directions of the peripheral walls 12b, 13b, and 14b.

The fuel cell pump 10 includes a seal member 31. The seal member 31 is disposed closer to the motor chamber 21 than the bearing 27 inside the through-hole 17. The seal member 31 provides a seal between the drive shaft 24 and the inner peripheral surface of the through-hole 17. The fuel cell pump 10 includes a seal member 32. The seal member 32 is disposed between the bearing 28 and the pump chamber 23 inside the through-hole 19. The seal member 32 provides a seal between the drive shaft 24 and the inner peripheral surface of the through-hole 19. The fuel cell pump 10 includes a seal member 33. The seal member 33 is disposed between the bearing 30 and the pump chamber 23 inside the through-hole 20. The seal member 33 provides a seal between the driven shaft 25 and the inner peripheral surface of the through-hole 20.

The fuel cell pump 10 includes a motor 34. The motor 34 is accommodated in the motor chamber 21. Thus, the motor chamber 21 accommodates the motor 34. The motor 34 includes a motor rotor 35 and a motor stator 36. The motor rotor 35 is cylindrical. The motor rotor 35 is fixed to the drive shaft 24. The motor rotor 35 is configured to rotate integrally with the drive shaft 24. The motor stator 36 is cylindrical. The motor stator 36 is fixed to the inner peripheral surface of the peripheral wall 12b of the motor housing member 12. The motor stator 36 surrounds the motor rotor 35. The motor stator 36 includes a motor coil 37. The motor 34 is driven by power supplied to the motor coil 37. When the motor 34 is driven, the motor rotor 35 rotates integrally with the drive shaft 24. In this manner, the motor 34 rotates the drive shaft 24.

The fuel cell pump 10 includes a drive gear 38 and a driven gear 39. The drive gear 38 and the driven gear 39 are accommodated in the gear chamber 22. Therefore, the gear chamber 22 accommodates the drive gear 38 and the driven gear 39. The drive gear 38 has the shape of a disc. The drive gear 38 is fixed to the drive shaft 24. The driven gear 39 has the shape of a disc. The driven gear 39 is fixed to the driven shaft 25. The driven gear 39 meshes with the drive gear 38.

The drive gear 38 and the driven gear 39 mesh with each other and are accommodated in the gear chamber 22. Oil is enclosed in the gear chamber 22. The oil lubricates the drive gear 38 and the driven gear 39 and limits increases in the temperature of the drive gear 38 and the driven gear 39. The drive gear 38 and the driven gear 39 rotate while being put in the oil so as to be allowed to rotate at relatively high speeds without seizing or wearing.

The fuel cell pump 10 includes a drive rotor 40 and a driven rotor 41. The drive rotor 40 and the driven rotor 41 are accommodated in the pump chamber 23. Therefore, the pump chamber 23 accommodates the drive rotor 40 and the driven rotor 41. The drive rotor 40 is provided at the second end of the drive shaft 24. The drive shaft 24 is thus supported by the housing 11 in a cantilevered manner. The drive rotor 40 rotates integrally with the drive shaft 24. The driven rotor 41 is provided at the second end of the driven shaft 25. The driven shaft 25 is thus supported by the housing 11 in a cantilevered manner. The driven rotor 41 rotates integrally with the driven shaft 25. The driven rotor 41 meshes with the drive rotor 40. The drive rotor 40 and the driven rotor 41 are thus accommodated in the pump chamber 23 while meshing with each other.

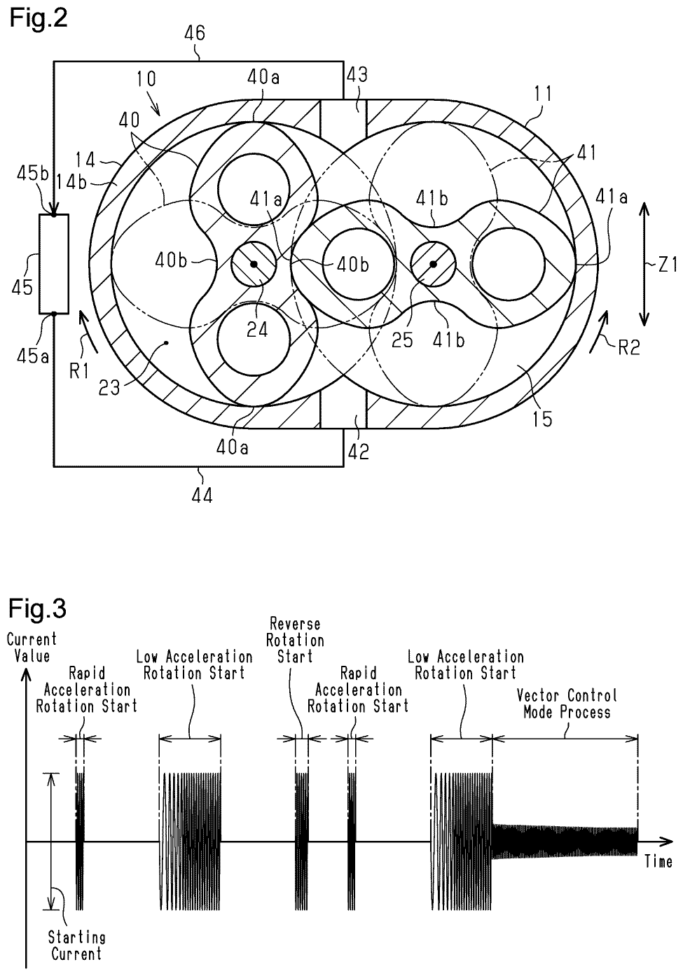

As shown in FIG. 2, the drive rotor 40 and the driven rotor 41 each have a bilobed (hourglass-shaped) form when viewed from the axial direction of the drive shaft 24 and the driven shaft 25. The drive rotor 40 includes two lobes 40a and two recesses 40b. Each recess 40b is formed between the lobes 40a. The driven rotor 41 includes two lobes 41a and two recesses 41b. Each recess 41b is formed between the lobes 41a.

The drive rotor 40 and the driven rotor 41 are capable of rotating in the pump chamber 23, while repeating meshing between the lobes 40a of the drive rotor 40 and the recesses 41b of the driven rotor 41, and meshing between the recesses 40b of the drive rotor 40 and the lobes 41a of the driven rotor 41. The drive rotor 40 rotates in a direction of arrow R1 in FIG. 2, and the driven rotor 41 rotates in a direction of arrow R2 in FIG. 2.

The peripheral wall 14b of the rotor housing member 14 includes a suction port 42 in a lower portion in a direction of gravitational force Z1. The peripheral wall 14b of the rotor housing member 14 includes a discharge port 43 in an upper portion in the direction of gravitational force Z1. The suction port 42 is connected to a hydrogen outlet 45a of a fuel cell 45 by a first connection pipe 44. The discharge port 43 is connected to a hydrogen supply port 45b of the fuel cells 45 via a second connection pipe 46.

As shown in FIGS. 1 and 2, when the motor 34 is driven to rotate the drive shaft 24, the driven shaft 25 rotates in a direction opposite to the rotating direction of the drive shaft 24 through the engagement of the drive gear 38 and the driven gear 39, which mesh with each other. This causes the drive rotor 40 and the driven rotor 41 to rotate in opposite directions while meshing with each other. In this manner, the drive rotor 40 and the driven rotor 41 rotate synchronously.

In the fuel cell pump 10, when the drive rotor 40 and the driven rotor 41 rotate synchronously, hydrogen off-gas, which is hydrogen that has not reacted with oxygen in the fuel cell 45, is drawn into the pump chamber 23 through the hydrogen outlet 45a, the first connection pipe 44, and the suction port 42. The hydrogen off-gas drawn into the pump chamber 23 is discharged from the discharge port 43 and is supplied to the fuel cell 45 through the second connection pipe 46 and the hydrogen supply port 45b due to the synchronous rotation of the drive rotor 40 and the driven rotor 41. In this manner, the fuel cell pump 10 supplies hydrogen to the fuel cell 45 through synchronous rotation of the drive rotor 40 and the driven rotor 41. The fuel cell pump 10 of the present embodiment is a Roots pump that includes the drive rotor 40 and the driven rotor 41.

### Control Unit

As shown in FIG. 1, the fuel cell pump 10 includes a control unit 50. The control unit 50 controls operation of the motor 34. The control unit 50 includes an inverter device. The control unit 50 may be 1) processing circuitry including one or more processors that operate according to a computer program (software); 2) processing circuitry including one or more dedicated hardware circuits such as application specific integrated circuits (ASICs) that execute at least part of various processes, or 3) processing circuitry including a combination thereof. The processor includes a CPU and memories such as a RAM and a ROM. The memories store program codes or commands configured to cause the CPU to execute processes. The memories, or computer-readable media, include any type of media that are accessible by general-purpose computers and dedicated computers.

The fuel cell pump 10 includes a cover 47. The cover 47 is attached to the end wall 12a of the motor housing member 12. The end wall 12a of the motor housing member 12 and the cover 47 define an inverter chamber 48. The inverter chamber 48 accommodates the control unit 50. In the present embodiment, the pump chamber 23, the gear chamber 22, the motor chamber 21, and the inverter chamber 48 are arranged in that order in the axial direction of the drive shaft 24 and the driven shaft 25.

The fuel cell pump 10 includes a temperature sensor 51 that detects a temperature. The temperature sensor 51 is electrically connected to the control unit 50. The temperature sensor 51 is configured to detect, for example, the temperature of the housing 11. The temperature of the housing 11 is a temperature related to the temperature in the pump chamber 23 or the temperature in the gear chamber 22. The control unit 50 receives a signal related to a temperature T1 detected by the temperature sensor 51. The control unit 50 pre-stores a temperature comparison program that compares the temperature T1 detected by the temperature sensor 51 with a preset temperature T2 based on the signal received from the temperature sensor 51. The control unit 50 pre-stores a process execution program. The process execution program causes the control unit 50 to execute a normal start mode process when the temperature T1 detected by the temperature sensor 51 is higher than the preset temperature T2. The process execution program causes the control unit 50 to execute a low-temperature start mode process when the temperature T1 detected by the temperature sensor 51 is lower than or equal to the preset temperature T2. Therefore, the control unit 50 executes the normal start mode process when the temperature T1 detected by the temperature sensor 51 is higher than the preset temperature T2, and executes the low-temperature start mode process when the temperature T1 detected by the temperature sensor 51 is lower than or equal to the preset temperature T2.

When the temperature T1 detected by the temperature sensor 51 is higher than the preset temperature T2, it is predicted that water inside the pump chamber 23 will not freeze even if water is present in the pump chamber 23. When the temperature T1 detected by the temperature sensor 51 is lower than or equal to the preset temperature T2, it is predicted that water will freeze in the pump chamber 23 if water is present in the pump chamber 23. Further, when the temperature T1 detected by the temperature sensor 51 is higher than the preset temperature T2, it is predicted that the viscosity of the oil in the gear chamber 22 is not high. When the temperature T1 detected by the temperature sensor 51 is lower than or equal to the preset temperature T2, it is predicted that the viscosity of the oil in the gear chamber 22 is relatively high. Such predictions are obtained in advance through experiments or the like. Thus, the preset temperature T2 is a temperature that is obtained in advance through experiments or the like to determine whether water freezes in the pump chamber 23 when present in the pump chamber 23, and to determine whether the viscosity of the oil is relatively high.

### Normal Start Mode Process

The control unit 50 pre-stores a program that supplies a starting current having a starting current value of a necessary minimum magnitude for starting the fuel cell pump 10 to the motor 34 for a necessary minimum time when the normal start mode process is executed. The period of the starting current supplied at the execution of the normal start mode process is always set to be constant.

### Low-Temperature Start Mode Process

The control unit 50 pre-stores a program that executes a rapid acceleration rotation start and then executes a low acceleration rotation start, when executing the low-temperature start mode process. In the rapid acceleration rotation start, the value of a starting current supplied to the motor 34 is set to be greater than that at the execution of the normal start mode process, and the rotational acceleration of the motor 34 is set to be greater than that at the execution of the normal start mode process. In the low acceleration rotation start, the value of the starting current supplied to the motor 34 is set to be greater than that at the execution of the normal start mode process, and the rotational acceleration of the motor 34 is set to be lower than that at the execution of the rapid acceleration rotation start. The rotational acceleration of the motor 34 refers to the amount of change in the rotation speed of the motor 34 per unit time.

The control unit 50 pre-stores a program that executes a reverse rotation start in addition to the rapid acceleration rotation start and the low acceleration rotation start, when executing the low-temperature start mode process. The control unit 50 thus executes the reverse rotation start in addition to the rapid acceleration rotation start and the low acceleration rotation start, when executing the low-temperature start mode process. In the reverse rotation start, the value of the starting current supplied to the motor 34 is set to be greater than that at the execution of the normal start mode process, and the motor 34 is rotated in the reverse direction.

The control unit 50 pre-stores a program that executes the reverse rotation start after executing the low acceleration rotation start. The control unit 50 thus executes the reverse rotation start after executing the low acceleration rotation start. The control unit 50 pre-stores a program that repeatedly executes the rapid acceleration rotation start, the low acceleration rotation start, and the reverse rotation start in that order, when executing the low-temperature start mode process. The control unit 50 thus repeatedly executes the rapid acceleration rotation start and the low acceleration rotation start, when executing the low-temperature start mode process.

FIG. 3 shows an example of a current waveform when the fuel cell pump 10 is started by executing the low-temperature start mode process. As shown in FIG. 3, in the rapid acceleration rotation start, the period of the starting current supplied to the motor 34 is set to be constant from the start of the rapid acceleration rotation start. The period of the starting current supplied to the motor 34 at the execution of the rapid acceleration rotation start is set to be shorter than the period of the starting current supplied to the motor 34 at the execution of the normal start mode process.

In the low acceleration rotation start, the period of the starting current supplied to the motor 34 is set so as to be gradually shortened after the low acceleration rotation start is started. The period of the starting current supplied to the motor 34 at the execution of the low acceleration rotation start is set to be shorter than the period of the starting current supplied to the motor 34 at the execution of the normal start mode process.

In the reverse rotation start, the period of the starting current supplied to the motor 34 is set to be constant from the start of the reverse rotation start. The way in which current flows to the motor 34 at the execution of the reverse rotation start is opposite to the way in which current flows to the motor 34 at the execution of the rapid acceleration rotation start. The period of the starting current supplied to the motor 34 at the execution of the reverse rotation start is substantially equal to the period of the starting current supplied to the motor 34 at the execution of the rapid acceleration rotation start.

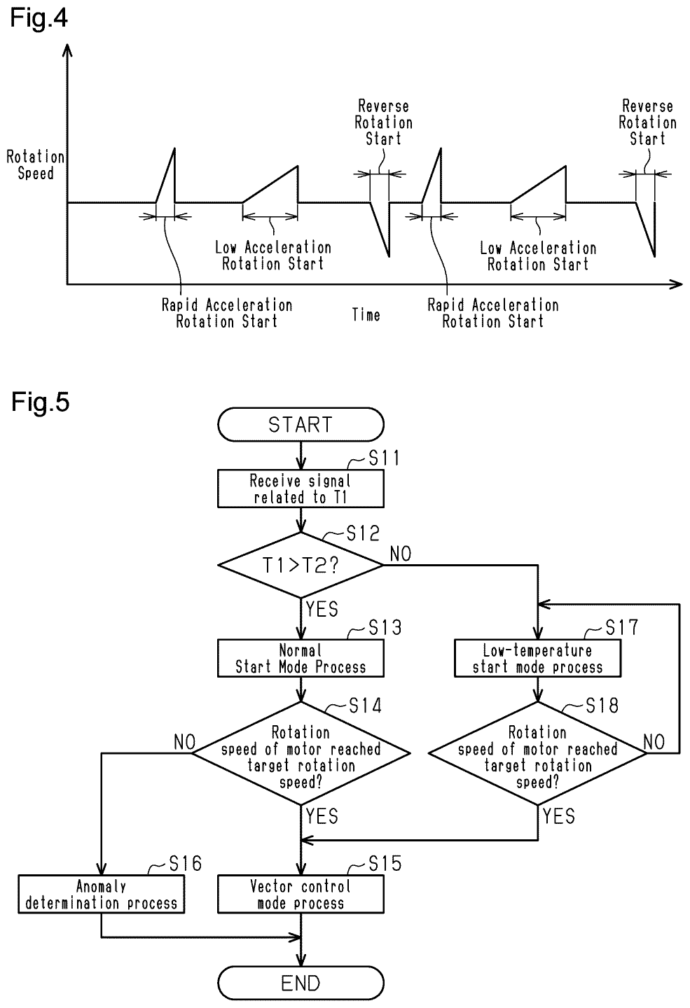

FIG. 4 shows changes in the rotation speed of the motor 34 in the low-temperature start mode process. As shown in FIG. 4, the inclination of the solid line indicating a change in the rotation speed of the motor 34 at the execution of the low acceleration rotation start is more gradual than the inclination of the solid line indicating a change in the rotation speed of the motor 34 at the execution of the rapid acceleration rotation start. Accordingly, the amount of change in the rotation speed of the motor 34 per unit time at the execution of the low acceleration rotation start is lower than the amount of change in the rotation speed of the motor 34 per unit time at the execution of the rapid acceleration rotation start. Therefore, the rotational acceleration of the motor 34 is lower in the low acceleration rotation start than in the rapid acceleration rotation start.

The inclination of the solid line indicating a change in the rotation speed of the motor 34 at the execution of the reverse rotation start is substantially equal to the inclination of the solid line indicating a change in the rotation speed of the motor 34 at the execution of the rapid acceleration rotation start. Accordingly, the amount of change in the rotation speed of the motor 34 per unit time at the execution of the reverse rotation start is substantially equal to the amount of change in the rotation speed of the motor 34 per unit time at the execution of the rapid acceleration rotation start. Thus, the rotational acceleration of the motor 34 at the execution of the reverse rotation start is substantially equal to the rotational acceleration of the motor 34 at the execution of the rapid acceleration rotation start. Therefore, the rotational acceleration of the motor 34 at the execution of the low acceleration rotation start is lower than the rotational acceleration of the motor 34 at the execution of the reverse rotation start.

When executing the low-temperature start mode process, the control unit 50 supplies the motor 34 with the starting current having a value that is approximately twice the value of the starting current supplied to the motor 34 at the execution of the normal start mode process. The value of the starting current supplied to the motor 34 is the same at the execution of each of the rapid acceleration rotation start, the low acceleration rotation start, and the reverse rotation start. The rotational acceleration of the motor 34 is higher at the execution of the rapid acceleration rotation start than at the execution of the normal start mode process.

### Vector Control Mode Process

The control unit 50 pre-stores a program that determines whether the rotation speed of the motor 34 has reached a target rotation speed. Specifically, the control unit 50 determines whether the rotation speed of the motor 34 has reached the target rotation speed by determining whether the value of the current supplied to the motor 34 has reached a current value corresponding to the target rotation speed of the motor 34.

During the execution of the low-temperature start mode process, the control unit 50 determines whether the rotation speed of the motor 34 has reached the target rotation speed after executing the rapid acceleration rotation start and the low acceleration rotation start. When determining that the rotation speed of the motor 34 has reached the target rotation speed, the control unit 50 determines that the fuel cell pump 10 has started operating. When determining that the rotation speed of the motor 34 has not reached the target rotation speed, the control unit 50 determines that the fuel cell pump 10 is in a stopped state. The “state in which the fuel cell pump 10 is in a stopped state” refers to a “state in which neither the drive rotor 40 nor the driven rotor 41 is rotating.” The “state in which the fuel cell pump 10 has started operating” refers to a “state in which the drive rotor 40 and the driven rotor 41 have started rotating”. The control unit 50 pre-stores a program that executes a vector control process that executes a sensorless vector control of the motor 34 when it is determined that the fuel cell pump 10 has started operating.

### Anomaly Determination Process

The control unit 50 pre-stores a program that executes an anomaly determination process for determining that some anomaly has occurred when it is determined that the rotation speed of the motor 34 has not reached the target rotation speed after the execution of the normal start mode process.

### Operation of Embodiment

Operation of the present embodiment will now be described.

As shown in FIG. 5, when it is necessary to start the fuel cell pump 10, the control unit 50 first receives a signal related to the temperature T1 detected by the temperature sensor 51 in step S11. Then, in step S12, the control unit 50 compares the temperature T1 detected by the temperature sensor 51 with the preset temperature T2 based on the signal received from the temperature sensor 51.

When the result of the comparison performed in step S12 indicates that the temperature T1 detected by the temperature sensor 51 is higher than the preset temperature T2, the control unit 50 advances the process to step S13. In step S13, the control unit 50 executes the normal start mode process. Specifically, the control unit 50 supplies a starting current that has the minimum value to start the fuel cell pump 10 to the motor 34 for the minimum amount of time. At this time, the period of the starting current supplied to the motor 34 is always constant.

In step S14, the control unit 50 determines whether the rotation speed of the motor 34 has reached the target rotation speed. When determining in step S14 that the rotation speed of the motor 34 has reached the target rotation speed, the control unit 50 advances the process to normal control in step S15. In step S15, the control unit 50 determines that the fuel cell pump 10 has started operating, and executes a vector control mode process for performing the sensorless vector control of the motor 34.

When determining in step S14 that the rotation speed of the motor 34 has not reached the target rotation speed, the control unit 50 advances the process to step S16. In step S16, the control unit 50 determines that some anomaly has been detected, and performs an anomaly determination process.

In the fuel cell pump 10, hydrogen off-gas, which has not reacted with oxygen in the fuel cell 45, is drawn into the pump chamber 23. The hydrogen off-gas contains water generated during power generation in the fuel cell 45. Thus, for example, when the operation of the fuel cell pump 10 is stopped in a low-temperature environment, water present in the pump chamber 23 freezes into ice. In the pump chamber 23, if water freezes into ice between the inner surface of the rotor housing member 14 defining the pump chamber 23 and the set of the drive rotor 40 and the driven rotor 41, the drive rotor 40 and the driven rotor 41 may be adhered to the rotor housing member 14 by the ice. When the operation of the fuel cell pump 10 is stopped in a low-temperature environment, the temperature of the oil in the gear chamber 22 drops. The viscosity of oil increases as the temperature decreases. The higher the viscosity of the oil, the more difficult it is for the drive gear 38 and the driven gear 39 to rotate when the fuel cell pump 10 is started.

When the result of the comparison performed in step S12 indicates that the temperature T1 detected by the temperature sensor 51 is lower than or equal to the preset temperature T2, the control unit 50 advances the process to step S17. In step S17, the control unit 50 executes the low-temperature start mode process. In the low-temperature start mode process, the control unit 50 first executes the rapid acceleration rotation start. As a result, the drive rotor 40 and the driven rotor 41 start rotating instantaneously at a commanded rotation speed corresponding to the starting current value. Therefore, even if, for example, the drive rotor 40 and the driven rotor 41 are adhered to the rotor housing member 14 by ice when the fuel cell pump 10 is started, the drive rotor 40 and the driven rotor 41 can be detached from the ice existing between the rotors 40, 41 and the inner surface of the rotor housing member 14.

Further, in the low-temperature start mode process, the control unit 50 executes the low acceleration rotation start after executing the rapid acceleration rotation start. Oil having a relatively high viscosity with the drive gear 38 and the driven gear 39 can be agitated more efficiently by gradually increasing the rotation speed of the drive gear 38 and the driven gear 39 to the commanded rotation speed corresponding to the starting current value than by causing the drive gear 38 and the driven gear 39 to rotate instantaneously at the commanded rotation speed. The control unit 50 sets the rotational acceleration of the motor 34 to a lower value at the low acceleration rotation start than at the execution of the rapid acceleration rotation start. Therefore, even if the viscosity of the oil is relatively high when starting the fuel cell pump 10, the oil inside the gear chamber 22 is efficiently agitated by the drive gear 38 and the driven gear 39, reducing the viscosity of the oil.

In step S17, after executing the rapid acceleration rotation start and the low acceleration rotation start in the first low-temperature start mode process, the control unit 50 advances the process to step S18. In step S18, the control unit 50 determines whether the rotation speed of the motor 34 has reached the target rotation speed. When determining in step S18 that the rotation speed of the motor 34 has not reached the target rotation speed, the control unit 50 advances the process to step S17 and executes the reverse rotation start of the first low-temperature start mode process. Accordingly, the drive rotor 40 and the driven rotor 41 rotate in the reverse direction. Therefore, even if, for example, the drive rotor 40 and the driven rotor 41 are adhered to the rotor housing member 14 by ice when the fuel cell pump 10 is started, the drive rotor 40 and the driven rotor 41 are readily detached from the ice existing between the rotors 40, 41 and the inner surface of the rotor housing member 14.

Further, at the second execution of the low-temperature start mode process, the control unit 50 once again executes the rapid acceleration rotation start and the low acceleration rotation start. In this manner, when determining that the rotation speed of the motor 34 has not reached the target rotation speed even after executing the low-temperature start mode process, the control unit 50 determines that the fuel cell pump 10 has not yet started and re-executes the low-temperature start mode process.

When determining in step S18 that the rotation speed of the motor 34 has reached the target rotation speed, the control unit 50 advances the process to the normal control in step S15. In step S15, the control unit 50 determines that the fuel cell pump 10 has started operating, and executes a vector control mode process for performing the sensorless vector control of the motor 34.

### Advantages of Embodiment

The above-described embodiment has the following advantages.
(1) When the temperature T1 detected by the temperature sensor 51 is lower than or equal to the preset temperature T2, the control unit 50 executes the low-temperature start mode process. In the low-temperature start mode process, the control unit 50 executes the rapid acceleration rotation start, in which the value of the starting current to the motor 34 is set to be greater than that at the execution of the normal start mode process, and the rotational acceleration of the motor 34 is set to be greater than that at the execution of the normal start mode process. As a result, the drive rotor 40 and the driven rotor 41 start rotating instantaneously at a commanded rotation speed corresponding to the starting current value. Therefore, even if, for example, the drive rotor 40 and the driven rotor 41 are adhered to the rotor housing member 14 by ice when the fuel cell pump 10 is started, the drive rotor 40 and the driven rotor 41 can be detached from the ice existing between the rotors 40, 41 and the inner surface of the rotor housing member 14. As a result, when the fuel cell pump 10 is started, the drive rotor 40 and the driven rotor 41 are readily rotated.

In the low-temperature start mode process, after executing the rapid acceleration rotation start, the control unit 50 executes the low acceleration rotation start, in which the value of the starting current supplied to the motor 34 is set to be greater than that at the execution of the normal start mode process, and the rotational acceleration of the motor 34 is set to be lower than that at the execution of the rapid acceleration rotation start. Oil having a relatively high viscosity with the drive gear 38 and the driven gear 39 can be agitated more efficiently by gradually increasing the rotation speed of the drive gear 38 and the driven gear 39 to the commanded rotation speed corresponding to the starting current value than by causing the drive gear 38 and the driven gear 39 to rotate instantaneously at the commanded rotation speed. As described above, the control unit 50 sets the rotational acceleration of the motor 34 to a lower value at the low acceleration rotation start than at the execution of the rapid acceleration rotation start. Therefore, even if the viscosity of the oil is relatively high when starting the fuel cell pump 10, the oil inside the gear chamber 22 is efficiently agitated by the drive gear 38 and the driven gear 39, reducing the viscosity of the oil. As a result, when the fuel cell pump 10 is started, the drive gear 38 and the driven gear 39 are readily rotated.

When the temperature T1 detected by the temperature sensor 51 is higher than the preset temperature T2, the control unit 50 executes the normal start mode process. Therefore, for example, when starting the fuel cell pump 10, the control unit 50 does not unnecessarily set the value of the starting current supplied to the motor 34 to be greater than that at the execution of the normal start mode process if the drive rotor 40 and the driven rotor 41 are not adhered to the rotor housing member 14 by ice. Further, for example, when starting the fuel cell pump 10, the control unit 50 does not unnecessarily set the value of the starting current supplied to the motor 34 to be greater than that at the execution of the normal start mode process if the viscosity of the oil is not high. As a result, unnecessary large starting current values will not be supplied to the motor 34, preventing excessive power consumption. Thus, while suppressing unnecessary power consumption, the time required to start the fuel cell pump 10 is reduced.
(2) The control unit 50 repeatedly executes the rapid acceleration rotation start and the low acceleration rotation start in the low-temperature start mode process. This makes it easier to detach the drive rotor 40 and the driven rotor 41 from the ice present between the inner surface of the rotor housing member 14 and the rotors 40, 41. Additionally, the oil inside the gear chamber 22 is agitated efficiently by the drive gear 38 and the driven gear 39. Thus, the fuel cell pump 10 is readily started.
(3) The control unit 50 executes the reverse rotation start in addition to the rapid acceleration rotation start and the low acceleration rotation start in the low-temperature start mode process. In the reverse rotation start, the control unit 50 sets the value of the starting current supplied to the motor 34 to be greater than that at the execution of the normal start mode process, and rotates the motor 34 in the reverse direction. Accordingly, the drive rotor 40 and the driven rotor 41 rotate in the reverse direction. Therefore, even if, for example, the drive rotor 40 and the driven rotor 41 are adhered to the rotor housing member 14 by ice when the fuel cell pump 10 is started, the drive rotor 40 and the driven rotor 41 are readily detached from the ice existing between the rotors 40, 41 and the inner surface of the rotor housing member 14. As a result, the fuel cell pump 10 is readily started.
(4) For example, a case will now be considered in which the control unit 50 executes the reverse rotation start after executing the rapid acceleration rotation start. In this case, even if the rapid acceleration rotation start has already detached the drive rotor 40 and the driven rotor 41 from the ice between the rotors 40, 41 and the inner surface of the rotor housing member 14, making the reverse rotation start unnecessary, the control unit 50 still executes the reverse rotation start. After executing the reverse rotation start, the control unit 50 executes the low acceleration rotation start. In contrast, in the present embodiment, the control unit 50 executes the reverse rotation start after executing the low acceleration rotation start. This efficiently starts the fuel cell pump 10.
(5) The control unit 50 executes the reverse rotation start in the low-temperature start mode process, so that the drive gear 38 and the driven gear 39 rotate in the reverse direction. Accordingly, the oil in the gear chamber 22 is agitated by the drive gear 38 and the driven gear 39. Since the control unit 50 executes the reverse rotation start, so that the drive gear 38 and the driven gear 39 efficiently agitate the oil in the gear chamber 22, the fuel cell pump 10 is started more readily.
(6) The heat of the motor 34 generated by the execution of the rapid acceleration rotation start and the low acceleration rotation start in the low-temperature start mode process is transmitted to the drive gear 38, the driven gear 39, the drive rotor 40, and the driven rotor 41. This increases the temperature in the gear chamber 22 and the temperature in the pump chamber 23. The temperature of the oil is also increased, so that the ice present in the pump chamber 23 will be melted. This efficiently starts the fuel cell pump 10.

### Modifications

The above-described embodiment may be modified as follows. The above-described embodiment and the following modifications can be combined as long as the combined modifications remain technically consistent with each other.

In the above-described embodiment, the control unit 50 does not necessarily need to repeatedly execute the rapid acceleration rotation start and the low acceleration rotation start in the low-temperature start mode process.

In the above-described embodiment, the control unit 50 does not necessarily need to execute the reverse rotation start in the low-temperature start mode process.

In the above-described embodiment, the control unit 50 may execute the reverse rotation start after executing the rapid acceleration rotation start.

In the above-described embodiment, the temperature sensor 51 may be configured to detect, for example, the temperature in the pump chamber 23, or may be configured to detect, for example, the temperature in the gear chamber 22. The temperature sensor 51 may be configured to detect the outside air temperature, for example. In short, the temperature sensor 51 may detect any temperature as long as the detected temperature is related to the temperature in the pump chamber 23 or the temperature in the gear chamber 22.

In the above-described embodiment, the temperature sensor 51 may be provided in the housing 11 that defines the pump chamber 23, and the temperature in the pump chamber 23 may be estimated based on the temperature detected by the temperature sensor 51. The temperature sensor 51 may be provided in the housing 11 that defines the gear chamber 22, and the temperature in the gear chamber 22 may be estimated based on the temperature detected by the temperature sensor 51.

In the above-described embodiment, the fuel cell pump 10 may include a pressure sensor. The pressure sensor detects the pressure of hydrogen that is discharged from the pump chamber 23 through the discharge port 43 to the second connection pipe 46 through rotation of the drive rotor 40 and the driven rotor 41. The control unit 50 may determine that the fuel cell pump 10 has been started when receiving a detection signal of the discharge pressure from the pressure sensor, and may determine that the fuel cell pump 10 is in a stopped state when not receiving detection signal of the discharge pressure from the pressure sensor.

In above-described embodiment, when executing the low-temperature start mode process, the control unit 50 may supply the motor 34 with a starting current having a value that is approximately three times the value of the starting current that is supplied to the motor 34, when executing the normal start mode process. In other words, in the rapid acceleration rotation start, the value of the starting current supplied to the motor 34 may be changed as long as the value is greater than that at the execution of the normal start mode process. In the low acceleration rotation start, the value of the starting current supplied to the motor 34 may be changed as long as it is greater than that at the execution of the normal start mode process. In the reverse rotation start, the value of the starting current supplied to the motor 34 may be changed as long as it is greater than that at the execution of the normal start mode process.

In the above-described embodiment, in the second and subsequent executions of the low-temperature start mode process, the control unit 50 may advance the process to step S18 at the time when the rapid acceleration rotation start is executed, and may determine whether the rotation speed of the motor 34 has reached the target rotation speed in step S18. In other words, the low-temperature start mode process may be modified as long as the process of the low acceleration rotation start is executed at least once after the rapid acceleration rotation start is executed.

In the above-described embodiment, step S14 and step S18 may be omitted. That is, in FIG. 5, when unable to advance the process from step S13 to step S15, the control unit 50 may attempt to advance the process from step S13 to step S15 again. In FIG. 5, when unable to advance the process from step S17 to step S15, the control unit 50 may attempt to advance the process from step S17 to step S15 again.

In the above-described embodiment, the value of the starting current supplied to the motor 34 may be different at the execution of each of the rapid acceleration rotation start, the low acceleration rotation start, and the reverse rotation start. The value of the starting current supplied to the motor 34 at the execution of each of the rapid acceleration rotation start, the low acceleration rotation start, and the reverse rotation start may be changed as long as it is greater than the value of the starting current supplied to the motor 34 at the execution of the normal start mode process.

In the above-described embodiment, the drive rotor 40 and the driven rotor 41 may have a three-lobe shape or a four-lobe shape when viewed from the rotation axis direction of the drive shaft 24 and the driven shaft 25.

In the above-described embodiment, the drive rotor 40 and the driven rotor 41 may be, for example, helical.

In the above-described embodiment, the fuel cell pump 10 is used as a pump that supplies hydrogen to a fuel cell that generates power by producing a chemical reaction of hydrogen as a fuel gas with oxygen as an oxidant gas contained in the air. Instead, the fuel cell pump 10 may be a pump that supplies air to the fuel cell.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A fuel cell pump, comprising:
a drive shaft and a driven shaft;
a motor configured to rotate the drive shaft;
a drive gear fixed to the drive shaft;
a driven gear fixed to the driven shaft and meshing with the drive gear;
a drive rotor configured to rotate integrally with the drive shaft;
a driven rotor configured to rotate integrally with the driven shaft and to mesh with the drive rotor;
a housing including:
a gear chamber that accommodates the drive gear and the driven gear, oil being sealed in the gear chamber; and
a pump chamber that accommodates the drive rotor and the driven rotor; and
a control unit configured to control operation of the motor, wherein
the fuel cell pump is configured to supply a fuel gas or an oxidant gas to a fuel cell through synchronous rotation of the drive rotor and the driven rotor,
the control unit is configured to be electrically connected to a temperature sensor configured to detect a temperature,
the control unit includes processing circuitry,
the processing circuitry is configured to
execute a normal start mode process when the temperature detected by the temperature sensor is higher than a preset temperature, and
execute a low-temperature start mode process when the temperature detected by the temperature sensor is lower than or equal to the preset temperature,
the low-temperature start mode process is a process of executing a rapid acceleration rotation start and then executing a low acceleration rotation start, and
the processing circuitry is configured to
in the rapid acceleration rotation start, set a value of a starting current supplied to the motor to be greater than that at the execution of the normal start mode process, and set a rotational acceleration of the motor to be higher than that at the execution of the normal start mode process, and
in the low acceleration rotation start, set the value of the starting current supplied to the motor to be greater than that at the execution of the normal start mode process, and set the rotational acceleration of the motor to be lower than that at the execution of the rapid acceleration rotation start.

2. The fuel cell pump according to claim 1, wherein the processing circuitry is configured to repeatedly execute the rapid acceleration rotation start and the low acceleration rotation start in the low-temperature start mode process.

3. The fuel cell pump according to claim 1, wherein
the processing circuitry is configured to, in the low-temperature start mode process, execute a reverse rotation start in addition to the rapid acceleration rotation start and the low acceleration rotation start, and
the processing circuitry is configured to, in the reverse rotation start, set the value of the starting current supplied to the motor to be greater than that at the execution of the normal start mode process, and rotate the motor in a reverse direction.

4. The fuel cell pump according to claim 3, wherein the processing circuitry is configured to execute the reverse rotation start after executing the low acceleration rotation start.
